(19) United States
(12) Patent Application Publication
(10) Pub. No.: US 2008/0245332 A1
(43) Pub. Date: Oct. 9, 2008

(54) Method For Starting a Hybrid Vehicle Heat Engine

(75) Inventors: Stephane Rimaux, Meudon (FR); Janette Rimaux, Meudon (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/091,058

(22) PCT Filed: Oct. 9, 2006
(86) PCT No.: PCT/FR06/51006

§ 371 Date: Apr. 21, 2008

(30) Foreign Application Priority Data
Oct. 20, 2005 (FR) 0510717

(51) Int. Cl. F02N 11/00

(52) U.S. Cl. 123/179.24

(57) ABSTRACT

The invention concerns a method applicable to a motor vehicle parallel hybrid drive train, comprising a heat engine, at least one electrical machine, a variable speed ratio transmission member, a first clutch linking the heat engine to the electrical machine, and a second clutch linking the transmission member to the electrical machine or to the heat engine. The method includes the following successive steps which consist in: a) placing the first clutch in open position; b) after positioning the second clutch in slip control, powering the electrical machine so as to drive same with kinetic energy higher than the energy required for starting the heat engine; and c) closing the first clutch so as to transmit, from the electrical machine to the heat engine, an energy at least sufficient to compensate the resisting torque of the heat engine shaft, and drive same at a starting speed.

The present invention concerns a method for starting an internal combustion engine of a motor vehicle parallel hybrid traction drive.

The term “parallel hybrid traction drive” is defined as a traction drive providing mechanical energy to a wheel shaft from at least one “non-reversible”-type motor (generally a heat engine) and at least one “reversible”-type motor (generally an electrical machine), and in which the energy node originating from the two motors is mechanical in nature.

Hereinafter, the non-reversible motor can be designated by the term “heat engine”, and the reversible motor by the term “electrical machine (or motor)”, with the understanding that this electric motor is operable in a motor mode and a generator mode.

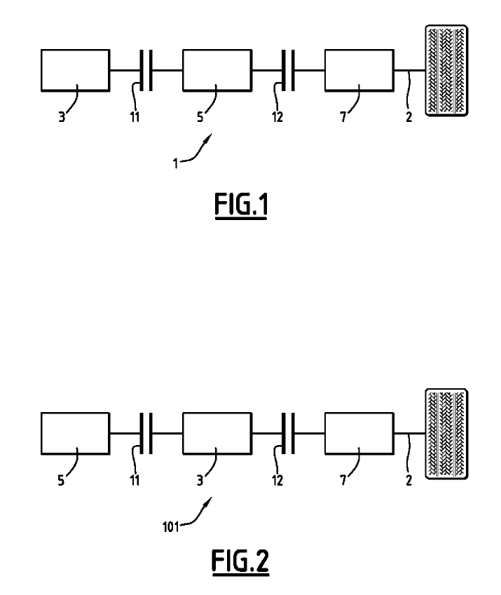

FIGS. 1 and 2 show schematically two architectures for parallel hybrid traction drives of a known type, e.g., from French patent application published under No. 2814121, to which the invention more particularly applies.

In a first architecture, illustrated in FIG. 1, the traction drive 1 essentially comprises, from upstream to downstream toward a wheel shaft 2: a heat engine 3, an electric motor 5, and a variable speed ratio transmission member 7 (also called a speed controller), such as a gearbox.

The traction drive 1 additionally comprises a first clutch 11 linking the heat engine 3 to the electrical machine 5, and a second clutch 12 linking the electrical machine 5 to the transmission member 7.

The clutches 11, 12 can be dry clutches, but in the context of the invention, they will be preferably wet clutches.

The traction drive in FIG. 1 can thus operate in a pure electrical mode, in which the clutch 11 is open so that it does not transmit any torque between the electrical machine 5 and the heat engine 3, and in which the electrical machine 5 alone provides mechanical energy to, or draws energy from, the wheel shaft 2.

This traction drive 1 can also operate in hybrid modes, in which the clutch 11 is sliding or closed in order to transmit torque between the heat engine 3 and the electrical machine 5.

According to a second architecture, the traction drive 101 in FIG. 2 differs from that in FIG. 1, essentially in that the heat engine 3 is placed operationally downstream of the electrical machine 5, with the second clutch 12 linking the heat engine 3 (not the electrical machine 5) to the transmission member 7.

In this second known architecture, the traction drive 101 operates in a hybrid mode in which the first clutch 11 is sliding or closed, so that it transmits torque between the electrical machine 5 and the heat engine 3.

In this second architecture, in contrast to the first, the traction drive does not have a pure electrical operating mode.

The invention thus relates more particularly to a starting method for a heat engine of a motor vehicle parallel hybrid traction drive, said traction drive comprising said heat engine, an electrical machine, a variable speed ratio transmission member, a first clutch linking the heat engine to the electrical machine, and a second clutch linking the transmission member to the electrical machine or to the heat engine.

In the case of the first architecture, an object of the invention is a method for starting the heat engine from a pure electrical driving mode or from a stop phase.

In the case of the second architecture, an object of the invention is a method for starting the heat engine from a vehicle stop phase.

In known hybrid traction drives, as described with reference to FIGS. 1 and 2, the heat engine is started by closing the first clutch 11 and suddenly increasing the electrical power provided by the electrical machine 5. Since the inertia of the heat engine is very high, the heat engine starting phase requires that the electrical machine be of a significant size, and that it provide a significant supply of electrical energy.

This is a drawback from the standpoint of the space required and the cost of the electrical machine and its power electronics.

In addition, during the heat engine starting phase, this energy input causes significant variations in torque at the wheel, which are felt by the users of the vehicle.

An objective of the invention is to remedy these drawbacks, and to propose a starting method of the kind previously set out that makes it possible to reduce the size of the electrical machine and to reduce or even eliminate surges in torque at the wheel during heat engine start-up.

To this end, an object of the invention is a method of the kind previously set out, characterized in that it has the following consecutive stages consisting in:

a) placing the first clutch in an open position;

b) supplying power to the electrical machine so as to drive it in motor mode, at a speed that imparts to its rotor a level of kinetic energy greater than the energy needed to crank the heat engine, and

c) closing the first clutch so as to transmit at least enough energy from the electrical machine to the heat engine to offset the resisting torque of the heat engine shaft, and to drive the latter at a cranking speed.

Preferably, during stage b), the electrical machine is supplied with enough power to deliver its maximum torque.

According to optional characteristics of the method according to the invention, applied to the first architecture:

the second clutch is controlled so as to keep the input speed and torque of the transmission member substantially constant; and

the method has the following stages, which are performed after the heat engine starts, consisting in:

d) bringing the heat engine up to a speed greater than the input speed of the transmission member, and greater than or equal to a set minimum speed for a set transition period, and

e) closing the second clutch.

According to optional characteristics of the method according to the invention, applied to the second architecture:

previous to stage a), the respective rotational speeds of the electrical machine and the heat engine are increased at the transmission member input, so as to reach a set speed that enables the vehicle to start off; and

after stage f), the second clutch is closed.

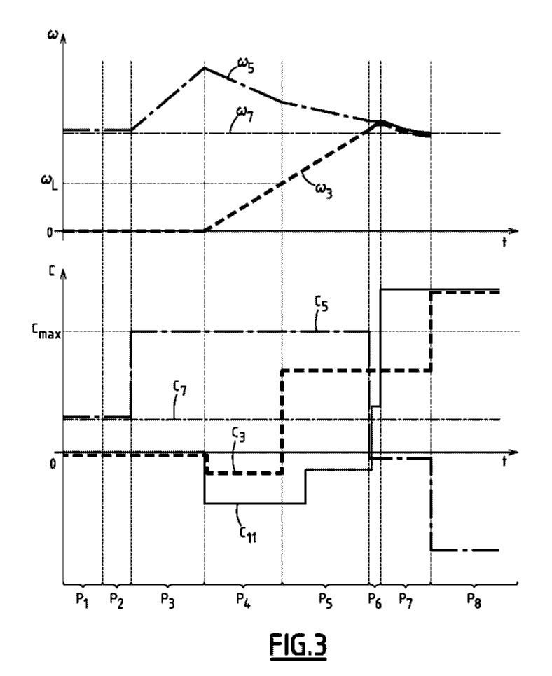

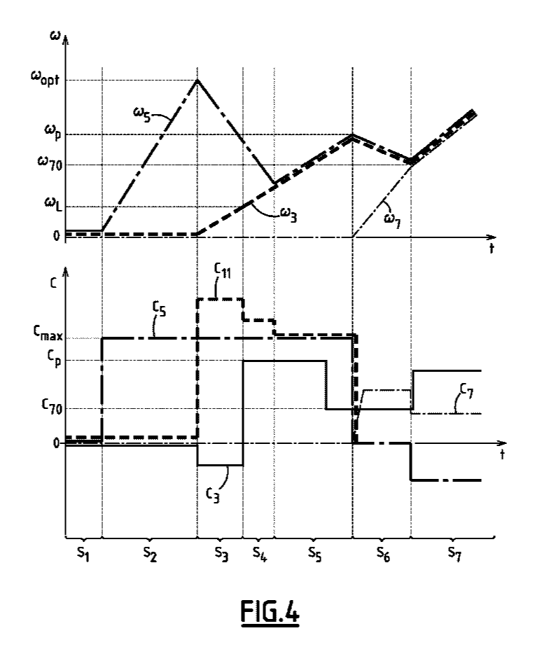

Particular embodiments of the invention will now be described in more detail, with reference to FIGS. 3 and 4 of the attached drawings, in which:

FIG. 3 is a graph illustrating the change over time in the rotational speeds and torques in a traction drive according to the first architecture during the execution of a starting method according to the invention; and

FIG. 4 is a figure comparable to FIG. 3, for a traction drive according to the second architecture.

In FIGS. 3 and 4, as a function of time t, shown on the abscissa, we have plotted the changes in the following shaft rotation speeds oh, and the following torques C:

ω₃, which is the rotational speed of the heat engine 3 shaft;

ω₅, which is the rotational speed of the rotor of the electrical machine 5;

ω₇, which is the rotational speed of the input shaft of the speed controller 7; and

C₃, which is the torque of the heat engine 3 shaft;

C₅, which is the torque of the rotor of the electrical machine 5;

C₇, which is the torque of the input shaft of the speed controller 7;

C₁₁, which is the torque transmitted by the clutch 11 from the heat engine 3 to the electrical machine 5.

In the examples shown, and in order to simplify the graphs, the torques exhibit a crenelated profile representing near-instantaneous variations corresponding to an ideal situation.

### First Architecture

First, with reference to FIG. 3, we will describe a starting method according to the invention for the first architecture, shown in FIG. 1.

In the example shown, the starting method is performed from a pure electrical drive mode, in which the second clutch 12 is transmitting torque between the electrical machine 5 and the speed controller 7; the first clutch 11 is open and is not transmitting any torque between the electrical machine 5 and the heat engine 3.

Thus, at the initial instant t=0, the speed controller 7 input rotation 0)7 and torque C₇ are not zero.

The starting method illustrated in FIG. 3 can be broken down into eight consecutive phases, hereinafter referred to and referenced in the figure as P₁ to P₈.

Throughout the starting method consisting in these eight phases, the second clutch 12 is controlled in order to respond at least partially to the driver's request (in the form of more or less pressure on the accelerator pedal) and to keep the users from experiencing jolts when the heat engine starts up.

In the remainder of the description, we will consider an example in which the target speed is constant.

First phase P₁:

In the initial state in pure electrical drive, with the first clutch 11 open and the second clutch 12 closed, the speed controller 7 input rotation ω₇ is equal to the rotational speed ω₅ of the electrical machine 5, while the rotational speed ω₃ of the heat engine 3 is zero.

Likewise, the speed controller 7 input torque C₇ is equal to the torque C₅ developed by the electrical machine 5, the heat engine 3 torque C₃ being zero.

Second phase P₂:

At the beginning of this phase, the decision to start the heat engine 3 is made by a computer (not shown) which implements a pre-programmed traction drive control strategy.

The second clutch 12 is moved to the slip limit.

The rotational speeds ω₃, ω₅, ω₇ and the torques C₃, C₅, C₇ are kept at the same levels as in phase 1.

Third phase P₃:

The electrical machine is suddenly supplied with full power so as to reach its maximum torque Cₘₐₓ and increase its rotational speed. The transition to maximum torque is nearly instantaneous at the beginning of phase 3, with the rotational speed being gradually increased to its maximum at the end of phase 3.

The torque transmitted by the second clutch 12 is still being regulated so as to maintain C₇ constant at the speed controller 7 input.

During this phase, the first clutch 11 remains open, so that the transmitted torque C₁₁ remains zero.

During the third phase P₃, the kinetic energy of the rotor of the electrical machine 5 is increased to a level greater than the energy needed to crank the heat engine 3, which is determined from a map, for example.

Fourth phase P₄:

With the electric motor 5 at its maximum torque, the first clutch 11 is positioned to slide while transmitting a torque C₁₁ greater than the frictional resisting torque of the heat engine 3.

The rotational speed ω₅ of the electric motor 5 decreases gradually, while the heat engine speed ω₃ increases gradually to a cranking speed ω_{L} at the end of the fourth phase P₄.

In the fourth phase P₄, the kinetic energy accumulated by the electrical machine 5 during phase P₃ is used to offset the inertia and the friction of the heat engine 3 shaft and to drive the latter at cranking speed ω_{L}.

The heat engine 3 can then run through the first compression strokes and begin to operate autonomously.

Fifth phase P₅:

The first clutch 11 remains in slip position, while allowing transmission of torque to help the heat engine 3 rev up.

The heat engine 3 torque becomes positive so that its rotational speed can overtake the speed of the input shaft of the speed controller 7.

At the end of phase 5, the rotational speeds ω₃ of the heat engine 3 and ω₇ of the controller 7 input shaft intersect.

Until the end of phase 5, the torque C₅ is maintained at its maximum level Cₘₐₓ.

Sixth phase P₆:

The first clutch 11 is moved to closed position.

The torque C₅ of the electric motor 5 and the second clutch 12 are still being controlled so as to transmit a torque such that the torque C₇ remains constant, but also in such a way that the rotational speed ω₅ of the electrical machine 5 remains greater than the speed controller 7 input speed ω₇.

Because the clutch 11 is closed, the rotational speed ω₃ becomes equal to the rotational speed ω₅.

From this phase on, the torque C₅ of the electrical machine 5 decreases to a level less than its maximum value Cₘₐₓ, and then the electrical machine 5 can operate in motor or generator mode. In other words, the torque C₅ can be motor torque or resisting torque, depending on the speed controller 7 input torque setpoint.

In the example shown, the torque C₅ becomes resisting torque from phase 6 on.

Seventh phase P₇:

During this phase, the second clutch 12 is gradually closed so that the rotational speeds ω₃, ω₅ of the heat engine 3 and the electrical machine 5 decrease to converge with the speed controller 7 input speed ω₇. The latter is kept constant following a desired profile. If the rotational speed ω₇ is below a set minimum threshold, the respective speeds ω₃ and ω₅ of the heat engine 3 and the electrical machine 5 are kept above this minimum value while waiting for the speed ω₇ to increase and go above this threshold.

Eighth phase P₈:

This phase represents the end of the starting process, with the heat engine 3 in operation, the two clutches 11 and 12 closed, and the rotational speeds ω₃ of the heat engine 3 and ω₅ of the electrical machine 5 coincide with the speed controller 7 input speed ω₇.

### Second Architecture

In FIG. 4, we have illustrated a starting method according to the invention for the second hybrid traction drive architecture, shown in FIG. 2.

The starting method is performed from a vehicle stop phase, in which the two clutches 11, 12 are open so as to transmit no torque.

The method is described hereinafter, broken down into seven consecutive phases, referenced S₁ to S₇.

First phase S₁:

This phase corresponds to the initial state of the system, in which the two clutches 11, 12 are open, and the heat engine 3 and the electrical machine 5 are off.

During this phase S₁, we are awaiting the decision to start the heat engine 3.

It is understood that this stage can also be carried out, when the vehicle is stopped, with a non-zero initial electrical machine speed ω₅.

Second phase S₂:

This phase consists in accumulating kinetic energy in the electrical machine 5.

To this end, the electrical machine 5 is supplied with full power in order to reach its maximum torque Cₘₐₓ, and this is done nearly instantaneously from the initial state.

The clutches 11, 12 remain open.

During this phase, the rotational speed ω₅ of the electrical machine 5 increases gradually to its optimal speed value ωₒₚₜ.

As in phase P₃ of the first embodiment, described in FIG. 3, the purpose of phase S₂ is to accumulate enough kinetic energy in the electrical machine 5 to offset the resisting torque of the engine shaft due to inertia and friction, to perform the first compression stroke, and to drive the heat engine 3 shaft at cranking speed ω_{L}.

Third phase S₃:

This is the heat engine 3 cranking phase.

The electrical machine 5 having reached its optimal speed ωₒₚₜ at the maximum torque Cₘₐₓ, the first clutch 11 is positioned so that the torque transmitted to the heat engine 3 is greater than the torque needed to start the heat engine 3.

In this phase, the second clutch 12 remains open.

During this phase, the torque C₃ of the heat engine 3 is a resisting torque, and the engine 3 speed ω₃ increases gradually to the cranking speed ω_{L}.

Fourth phase S₄:

The heat engine 3 turns over and its developed torque C₃ is increased to a level Cₚ to ensure that its rotational speed continues to increase, with a torque C₅ kept constant at its maximum value Cₘₐₓ.

The torque C₁₁ transmitted by the first clutch 11 can be adjusted to a value less than the torque reached during the third phase in order to reduce vibrational phenomena.

In this phase, the second clutch 12 is kept open.

During the third S₃ and fourth S₄ phases, the rotational speed ω₅ of the electrical machine 5 gradually decreases, and at the end of phase 4 reaches a level that remains greater than the cranking speed ω_{L}.

Fifth phase S₅:

At the beginning of this phase, the first clutch 11 is closed so that from the beginning of phase 5 until the end of the starting method, the rotational speed ω₅ remains equal to the rotational speed ω₃.

During this phase, the speeds ω₃ and ω₅ increase jointly to an intermediate so-called “start-off” value ω_{P} that is greater than the setpoint speed ω₇₀.

During this phase, as an example, the torque C₃ of the heat engine 3 C₃ is adjusted to a level C_{P} at the beginning of phase 4, and maintained at this level, and then is suddenly brought back to the setpoint level C₇₀.

Throughout phase S5, the torque C₅ is maintained at its maximum level Cₘₐₓ.

The purpose of this phase is to increase the rotational speeds ω₃ and ω₅ to reach a set target speed ω_{P} that makes it possible to start off.

This target speed cop can be fixed and prerecorded, e.g., in the form of a map, or calculated during start control from various parameters or variables related to the state of the heat engine 3.

Sixth phase S₆:

At the beginning of this phase, the second clutch 12 is moved to closed position, and the torque C₅ of the electrical machine 5 is suddenly decreased, e.g., to a zero value, so that the rotational speeds ω₅ and ω₃ of the electrical machine 5 and the heat engine 3 decrease together to the speed controller input setpoint value ω₇₀.

Seventh phase S₇:

This phase corresponds to initial hybrid-mode operation and to the end of the heat engine starting method.

In the example shown, during this phase S₇, the electrical machine 5 is operating as a generator, and generates a resisting (negative) torque in the traction drive, with the heat engine torque C₃ being adjusted to a level greater than that of phase S₆ in order to increase the speed controller input speed.

In the two embodiments just described, the heat engine is started by bringing the electrical machine to a high rotational speed and by using the kinetic energy of the rotor stored in this way, before the heat engine is mechanically connected to the electrical machine.

With the invention, the heat engine starting phase is not an overriding factor in designing the size of the electrical machine. In this way, it becomes possible for hybrid traction drives to use electrical machines whose power is limited to the needs and required performance of the various driving phases.

1. Method for starting a heat engine of a motor vehicle parallel hybrid traction drive said traction drive comprising said heat engine, at least one electrical machine, a variable speed ratio transmission member, a first clutch linking the heat engine to the electrical machine, and a second clutch linking the transmission member to the electrical machine or to the heat engine, wherein said method includes the consecutive stages:
a) placing the first clutch in open position;
b) after positioning the second clutch at the slip limit, supplying power to the electrical machine, so as to drive it in motor mode at a speed that imparts kinetic energy to its rotor greater than the energy needed to crank the heat engine, and
c) closing the first clutch so as to transmit at least enough energy from the electrical machine to the heat engine to offset the resisting torque of the heat engine shaft, and to drive the latter at a cranking speed.

2. Method according to claim 1, wherein during stage b), the electrical machine is supplied with enough power to deliver its maximum torque

3. Method according to claim 1, the traction drive being such that the second clutch links the electrical machine to the transmission member, with start-up being performed from a pure electric drive mode, wherein the second clutch is controlled in order to respond at least partially to the driver's request.

4. Method according to claim 3, which includes the following stages, which are performed after the heat engine turns over:
d) bringing the heat engine up to a speed greater than the input speed of the transmission member, and greater than or equal to a set minimum speed, and
e) closing the second clutch.

5. Method according to claim 1, the traction drive being such that the second clutch links the heat engine to the transmission member, with start-up being performed from a vehicle stop phase, wherein previous to stage a), the respective rotational speeds of the electrical machine and the heat engine are increased at the transmission member input, so as to reach a set speed that enables the vehicle to start off, and
after stage f), the second clutch is closed.

6. Method according to claim 5, wherein the rotational speed enabling vehicle start-off is determined from preset, fixed value.

7. Method according to claim 5, wherein the rotational speed enabling vehicle start-off is calculated during start control from various parameters or variables related to the state of the heat engine.

8. Method according to claim 2, the traction drive being such that the second clutch links the electrical machine to the transmission member, with start-up being performed from a pure electric drive mode, wherein the second clutch is controlled in order to respond at least partially to the driver's request.

9. Method according to claim 8, which includes the following stages, which are performed after the heat engine turns over:
d) bringing the heat engine up to a speed greater than the input speed of the transmission member, and greater than or equal to a set minimum speed, and
e) closing the second clutch.

10. Method according to claim 2, the traction drive being such that the second clutch links the heat engine to the transmission member, with start-up being performed from a vehicle stop phase, wherein previous to stage a), the respective rotational speeds of the electrical machine and the heat engine are increased at the transmission member input, so as to reach a set speed that enables the vehicle to start off, and
after stage f), the second clutch is closed.

11. Method according to claim 10, wherein the rotational speed enabling vehicle start-off is determined from preset, fixed values.

12. Method according to claim 10, wherein the rotational speed enabling vehicle start-off is calculated during start control from various parameters or variables related to the state of the heat engine.
